(19) United States
(12) Patent Application Publication
(10) Pub. No.: US 2023/0294077 A1
(43) Pub. Date: Sep. 21, 2023

(54) METHOD OF PRODUCING CATALYST FOR EXHAUST GAS PURIFICATION

(71) Applicant: TOYOTA JIDOSHA KABUSHIKI KAISHA, Toyota-shi (JP)

(72) Inventor: Norio ISHIKAWA, Toyota-shi (JP)

(73) Assignee: TOYOTA JIDOSHA KABUSHIKI KAISHA, Toyota-shi (JP)

(21) Appl. No.: 18/082,678

(22) Filed: Dec. 16, 2022

(30) Foreign Application Priority Data
Mar. 15, 2022 (JP) 2022-040119

(51) Int. Cl. B01J 23/44; B01J 37/02

(52) U.S. Cl. CPC B01J 23/44; B01J 37/0215; B01D 2255/1023; B01D 2255/1021; B01D 2255/9022; B01D 53/94

(57) ABSTRACT

The present disclosure relates to a method of producing a catalyst for exhaust gas purification, including: (i) a process in which a Pd precursor and a Pt precursor are dissolved in a solvent to prepare a solution containing Pd and Pt, the content of Pt with respect to a total weight of Pd and Pt being 85 weight % or less; and (ii) a process in which the solution containing Pd and Pt prepared in the process (i) is supported on a catalyst coating layer.

### CROSS-REFERENCE TO RELATED APPLICATION

This application claims priority to Japanese Patent Application No. 2022-040119 filed on Mar. 15, 2022, incorporated herein by reference in its entirety.

### BACKGROUND

### 1. Technical Field

The present disclosure relates to a method of producing a catalyst for exhaust gas purification.

### 2. Description of Related Art

Exhaust gases discharged from internal combustion engines for automobiles and the like, for example, internal combustion engines such as gasoline engines or diesel engines, include harmful components, for example, carbon monoxide (CO), hydrocarbons (HC), and nitrogen oxides (NOx).

Therefore, generally, an exhaust gas purification device for decomposing and removing these harmful components is provided in an internal combustion engine, and most of these harmful components are rendered harmless by a catalyst for exhaust gas purification installed in the exhaust gas purification device. As such a catalyst for exhaust gas purification, for example, ternary catalysts and NOx occlusion reduction catalysts are known.

Ternary catalysts are catalysts that cause CO and HC to be oxidized and NOx to be reduced at the same time in a stoichiometric (theoretical air-fuel ratio) atmosphere.

In addition, the NOx occlusion reduction catalysts are catalysts that cause NO in the exhaust gas to be oxidized to NO₂ and NO₂ to be occluded in a lean atmosphere and cause NO₂ to be reduced to nitrogen (N₂) in a stoichiometric atmosphere and a rich atmosphere, and successfully utilize changes in exhaust gas components in a lean atmosphere, a stoichiometric atmosphere, and a rich atmosphere.

However, even if these catalysts are used, purification of exhaust gases is still a problem, and various studies have been made.

For example, Japanese Unexamined Patent Application Publication No. 2006-255638 (JP 2006-255638 A) discloses a catalyst for exhaust gas purification including a substrate in which a plurality of cells through which an exhaust gas can flow are formed and at least (1) rhodium (Rh), (2) platinum (Pt) and/or palladium (Pd) as catalyst metals, wherein, among the plurality of cells, a cell containing rhodium does not contain platinum and palladium, and a cell containing platinum or palladium does not contain rhodium.

Japanese Unexamined Patent Application Publication No. 2012-040547 (JP 2012-040547 A) discloses a catalyst for exhaust gas purification including a substrate on which a gas flow path through which an exhaust gas flows is formed and a catalyst layer formed on the substrate, wherein the catalyst layer is composed of a lower catalyst layer formed on the surface of the substrate, a front upper catalyst layer covering the surface of the lower catalyst layer on the upstream side in the gas flow direction, and a rear upper catalyst layer covering the surface of the lower catalyst layer downstream from the front upper catalyst layer in the gas flow direction, the lower catalyst layer supports at least one of Pd and Pt, the rear upper catalyst layer supports Rh, the front upper catalyst layer supports Pd, and a carrier supporting Pd of the front upper catalyst layer is a ZrO₂ composite oxide containing Y₂O₃.

Japanese Unexamined Patent Application Publication No. 2016-140846 (JP 2016-140846 A) discloses a catalyst for exhaust gas purification that is disposed in an exhaust passage of an internal combustion engine and purifies an exhaust gas discharged from the internal combustion engine, and includes a substrate and a catalyst coating layer formed on the surface of the substrate, wherein the catalyst coating layer is formed in a laminated structure having upper and lower layers, with the side closer to the surface of the substrate being the lower layer and the side relatively farther from the surface of the substrate being the upper layer, the upper layer is a Pd-less layer containing no Pd, the lower layer is a Pd-containing layer containing Pd, and in the lower layer, when the region up to 20% of the length of the catalyst for exhaust gas purification from the end on the side of an exhaust gas inlet of the catalyst for exhaust gas purification toward an exhaust gas outlet is divided into four equal parts of 5%, the relationship between a content A of Pd in a first ¼ region on the furthest upstream side, a content B of Pd in a second ¼ region on the downstream side adjacent to the first region and a content C of Pd in a third ¼ region on the downstream side adjacent to the second region satisfies A>B>C.

Japanese Unexamined Patent Application Publication No. 2020-179348 (JP 2020-179348 A) discloses a catalyst for exhaust gas purification including a monolith substrate composed of a catalyst carrier and a catalyst coating layer coated on the monolith substrate, wherein the monolith substrate contains Pd supported on a catalyst carrier, the catalyst coating layer has a downstream-side coating layer formed from the end on the downstream side with respect to an exhaust gas flow direction in the catalyst for exhaust gas purification, the downstream-side coating layer contains Rh, the coating amount of the downstream-side coating layer is 10 g/L to 90 g/L per 1 L volume of a monolith substrate part coated with the downstream-side coating layer, the catalyst for exhaust gas purification is composed of an upstream part of the catalyst for exhaust gas purification which is in a range of 45% or less of the total length of the catalyst for exhaust gas purification from the upstream-side end in the exhaust gas flow direction in the catalyst for exhaust gas purification and a downstream part of the catalyst for exhaust gas purification which is in a range other than the upstream part of the catalyst for exhaust gas purification, and the upstream part of the catalyst for exhaust gas purification has a higher Pd concentration than the downstream part of the catalyst for exhaust gas purification.

### SUMMARY

As described in JP 2006-255638 A, JP 2012-040547 A, JP 2016-140846 A, and JP 2020-179348 A, precious metals such as Pd, Pt, and Rh are used as catalysts for exhaust gas purification. Purification performance of precious metals as catalysts differs per precious metal, and for example, Pd and Pt have a high ability to burn and remove HC and CO by purification, and Rh has a high ability to remove NOx by purification. Therefore, in order to detoxify two or more harmful components, in the catalyst for exhaust gas purification, a combination of a plurality of precious metals is generally used.

On the other hand, since Pd and Pt have the same harmful component purification performance, they can be treated as compatible precious metals as described in JP 2006-255638 A.

However, when favorable warm-up performance is required in a catalyst for exhaust gas purification, Pt is more likely to sinter after long-term use than Pd, and as a result, Pd is used more often than Pt which can reduce warm-up performance. Since the prices of precious metals such as Pt and Pd fluctuate greatly, for example, when the price of Pd is higher than the price of Pt, Pt and Pd cannot be used in equal amounts, that is, if it is desired to produce a catalyst for exhaust gas purification having favorable warm-up performance for which it is necessary to use Pd, the production cost will be high.

Therefore, the present disclosure provides a technique for designing a catalyst for exhaust gas purification having the a uniform performance without being influenced by precious metal price fluctuations, that is, a method of producing a catalyst for exhaust gas purification in which warm-up performance is maintained even if the amount of Pd used is reduced.

The inventors have studied various techniques for addressing the above problems, and as a result, found that, in production of a catalyst for exhaust gas purification, if a solution containing Pd and Pt at specific proportions is used when Pd and Pt are supported on a catalyst coating layer, even if the amount of Pd used is reduced, it is possible to produce a catalyst for exhaust gas purification that maintains warm-up performance, and completed the present disclosure.

That is, the scope of the present disclosure is as follows.
(1) A method of producing a catalyst for exhaust gas purification including:
(i) a process in which a Pd precursor and a Pt precursor are dissolved in a solvent to prepare a solution containing Pd and Pt, the content of Pt with respect to a total weight of Pd and Pt being 85 weight % or less in the solution; and
(ii) a process in which the solution containing Pd and Pt prepared in the process (i) is supported on a catalyst coating layer.
(2) The method according to (1), wherein, in the solution containing Pd and Pt prepared in the process (i), the content of Pt with respect to a total weight of Pd and Pt is 75 weight % or less.
(3) The method according to (l), wherein, in the process (ii), the solution containing Pd and Pt prepared in the process (i) is supported on the catalyst coating layer upstream from a substrate.
(4) A catalyst for exhaust gas purification, including:
   a substrate;
   a catalyst coating layer on the substrate; and
   Pd and Pt supported on the catalyst coating layer,
   wherein Pd and Pt are supported by applying a solution containing Pd and Pt obtained by dissolving a Pd precursor and a Pt precursor in a solvent to the catalyst coating layer, and
   wherein the content of Pt in the solution containing Pd and Pt with respect to a total weight of Pd and Pt is 85 weight % or less.

The present disclosure provides a method of producing a catalyst for exhaust gas purification that maintains warm-up performance even if the amount of Pd used is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between the proportion of Pt supported on a catalyst coating layer (excluding Pd contained in a lower catalyst coating layer) of an upstream part in catalysts for exhaust gas purification of Comparative Examples 1 to 6 and Examples 1 to 3 and the time of reaching HC-T50.

### DETAILED DESCRIPTION OF EMBODIMENTS

Hereinafter, preferable embodiments of the present disclosure will be described in detail.

In this specification, features of the present disclosure will be described with reference to the drawings appropriately. Here, a method of producing a catalyst for exhaust gas purification of the present disclosure is not limited to the following embodiments, and can be realized in various modes that may be modified and improved by those skilled in the art without departing from the spirit and scope of the present disclosure.

The present disclosure relates to a method of producing a catalyst for exhaust gas purification including (i) a process in which a Pd precursor and a Pt precursor are dissolved in a solvent to prepare a solution containing Pd and Pt, the content of Pt with respect to a total weight of Pd and Pt being 85 weight % or less and (ii) a process in which the solution containing Pd and Pt prepared in the process (i) is supported on a catalyst coating layer.

Processes (i) and (ii) will be described below.

### (i) Process in which a Pd Precursor and a Pt Precursor are Dissolved in a Solvent to Prepare a Solution Containing Pd and Pt

In the process (i) of the present disclosure, a Pd precursor and a Pt precursor are dissolved in a solvent to prepare a solution containing Pd and Pt.

Here, the content of Pt in the solution containing Pd and Pt with respect to a total weight of Pd and Pt is 85 weight % (wt. %) or less, and preferably 75 weight % or less. Here, Pd and Pt indicate the weights of Pd and Pt as metals.

In other words, the content of Pt in the solution containing Pd and Pt with respect to a total molar amount of Pd and Pt is 70 mol % or less, and preferably 65 mol % or less.

Here, the lower limit value of the content of Pt in the solution containing Pd and Pt is not limited as long as it exceeds 0 weight %, and can be appropriately adjusted according to desired performance of the catalyst for exhaust gas purification.

When the content of Pt in the solution containing Pd and Pt is set to be within the above range, even if the proportion of Pd in the catalyst for exhaust gas purification is reduced, it is possible to produce a catalyst for exhaust gas purification having a warm-up performance equal to or better than the favorable warm-up performance obtained when the proportion of Pd is 100%, that is, when Pt is not contained.

The content of Pd and Pt in the solution containing Pd and Pt is not limited, but contents of Pd and Pt for support in the solution containing Pd and Pt are adjusted so that the supported metal content is generally 1.0 g to 10 g, and preferably 5.0 g to 8.0 g per 1 L volume of the substrate.

When the contents of Pd and Pt are set to be within the above range, it is possible to sufficiently remove harmful components by purification, particularly, HC and CO, contained in the exhaust gas.

The solvent is not limited as long as it is a compound that can dissolve a Pd precursor and a Pt precursor to be described below. Examples of solvents include water, an alcohol, for example, methanol, ethanol, propanol, and butanol, and a mixture of water and an alcohol. Water is preferable as the solvent.

The amount of the solvent can be adjusted by the water absorption amount of the catalyst, that is, the water absorption amount of the substrate coated with the catalyst coating layer used in the process (ii), and the amount of precious metal supported, that is, the amount of Pd and Pt supported. The amount of the solvent is adjusted so that the concentration of Pd and Pt is generally 0.1 weight % to 10 weight %.

The Pd precursor is not limited as long as it is a compound that can be dissolved in the solvent described above. Examples of Pd precursors include halogen compounds such as chlorides and bromides, inorganic salts such as sulfates and nitrates, organic acid salts such as acetates and citrates, inorganic and organic complex salts such as dinitrodiammine nitrate and mixtures thereof. The Pd precursor may be prepared by dissolving metallic Pd with an acid or a base. A Pd nitrate aqueous solution is preferable as the Pd precursor.

The Pt precursor is not limited as long as it is a compound that can be dissolved in the solvent described above. Examples of Pt precursors include halogen compounds such as chlorides and bromides, inorganic salts such as sulfates and nitrates, organic acid salts such as acetates and citrates, inorganic and organic complex salts such as dinitrodiammine nitrate and mixtures thereof. The Pt precursor may be prepared by dissolving metallic Pt with an acid or a base. A Pt nitrate aqueous solution or a dinitrodiammine Pt nitric acid solution is preferable as the Pt precursor.

In the process (i) of the present disclosure, as long as the Pd precursor and the Pt precursor are dissolved in the solvent, the order of adding the solvent, the Pd precursor and the Pt precursor, the temperature during addition, and the addition method are not limited. For example, a solution containing Pd and Pt can be prepared by adding a Pd precursor and a Pt precursor to a solvent that is stirred at room temperature (20° C. to 30° C.) and additionally uniformly stirring the mixture.

For example, in the process (i) of the present disclosure, in the process (ii), when 5 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), 15 g of a solution (the concentration of precious metals (Pd and Pt): 5.57 weight %) containing 0.835 g of precious metals (Pd and Pt) as metals and a solvent can be prepared as the solution containing Pd and Pt.

In addition, in the process (i) of the present disclosure, in the process (ii), when the solution containing Pd and Pt is supported on the catalyst coating layer two or more times in a divided manner, two or more solutions containing Pd and Pt may be prepared.

For example, in the process (i) of the present disclosure, in the process (ii), when 10 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), two of 15 g of a solution (the concentration of precious metals (Pd and Pt): 5.57 weight %) containing 0.835 g of precious metals (Pd and Pt) as metals and a solvent can be prepared as the solution containing Pd and Pt.

For example, in the process (i) of the present disclosure, in the process (ii), when 8 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), 15 g of a first solution (the concentration of precious metals (Pd and Pt): 5.57 weight %) containing 0.835 g of precious metals (Pd and Pt) as metals and a solvent and 15 g of a second solution (the concentration of precious metals (Pd and Pt): 3.34 weight %) containing 0.501 g of precious metals (Pd and Pt) as metals and a solvent can be prepared as the solution containing Pd and Pt.

### (ii) Process in which the Solution Containing Pd and Pt Prepared in the Process (i) is Supported on a Catalyst Coating Layer

In the process (ii) of the present disclosure, the solution containing Pd and Pt prepared in the process (i) is supported on the catalyst coating layer.

Here, the catalyst coating layer is applied (coated) to the substrate. Examples of substrates include a monolith substrate, and a monolith substrate having a known honeycomb shape (for example, a honeycomb filter, a high-density honeycomb, etc.) can be used as the monolith substrate. In addition, the material of such a monolith substrate includes ceramics such as cordierite (for example, a compound represented by a composition of 2MgO·2Al₂O₃·5SiO₂), silicon carbide (SiC), and metals (including alloys) such as stainless steel.

As the substrate coated with the catalyst coating layer, for example, a substrate coated with a catalyst coating layer containing Pd on the substrate, a substrate coated with a catalyst coating layer containing Pt on the substrate, a substrate coated with catalyst coating layer containing Rh on the substrate, or a substrate coated with a first catalyst coating layer containing Pd on the substrate and coated with a second catalyst coating layer containing Rh on the first catalyst coating layer may be used. Here, as a catalyst coating layer application method, a technique known in the art such as a wash coating method can be used.

Each catalyst coating layer applied to the substrate includes powder carriers (catalyst carriers), for example, metal oxides, for example, silica (SiO₂), magnesium oxide (MgO), zirconia (ZrO₂), ceria (CeO₂), alumina (Al₂O₃, for example, θ-phase alumina), titania (TiO₂), yttria (Y₂O₃), neodymium oxide (Nd₂O₃) and solid solutions and composite oxides thereof, for example, mullite (for example, a compound represented by a composition of Al₆O₁₃Si₂), as well as combinations of two or more thereof, and precious metals supported on catalyst carriers, for example, Pd, Pt and Rh. Examples of catalyst carders include silica, alumina, mullite, ceria, zirconia, and composite oxides or solid solutions thereof (for example, ceria-zirconia composite oxides or solid solutions) as well as mixtures of two or more thereof, and it is preferable to contain a mixture of a ceria-zirconia composite oxide or ceria-zirconia-alumina composite oxide and alumina. In addition, these materials preferably contain additional elements generally used to improve heat resistance and purification performance.

As the catalyst carrier, zirconia inhibits sintering of other powder carriers at a high temperature at which the other powder carriers sinter, and according to combining with Rh as a catalyst metal, a steam reforming reaction occurs, H₂ is generated, and NOx can be efficiently reduced. Since ceria has an oxygen storage capacity (OSC) property of occluding oxygen in a lean atmosphere and releasing oxygen in a rich atmosphere, it is possible to maintain a stoichiometric atmosphere in the catalyst for exhaust gas purification, and thus ceria can be suitably used as a ternary catalyst or the like. Since an acid-base amphoteric carrier such as alumina has a large specific surface area, it is possible to inhibit sintering of precious metals. Titania can exhibit an effect of minimizing sulfur poisoning of catalyst metals.

The content of each precious metal contained in each catalyst coating layer applied to the substrate is not limited, but the metal content is adjusted so that it is generally 0.1 g to 1.0 g, and preferably 0.2 g to 0.5 g per 1 L volume of the substrate in consideration of catalyst performance in the catalyst for exhaust gas purification.

The coating amount of each catalyst coating layer applied to the substrate is not limited, but is generally 10 g/L to 300 g/L, and preferably 50 g/L to 250 g/L per 1 L volume of the substrate in consideration of a balance of pressure loss, catalyst performance, durability, and warm-up performance in the catalyst for exhaust gas purification.

The thickness of each catalyst coating layer applied to the substrate is not limited, but the average thickness is generally 5 to 200 μm, and preferably 10 μm to 100 μm in consideration of a balance of pressure loss, catalyst performance, durability, and warm-up performance in the catalyst for exhaust gas purification. The thickness of each catalyst coating layer can be measured using, for example, an SEM.

In the process (ii) of the present disclosure, the method for supporting the solution containing Pd and Pt prepared in the process (i) on the substrate coated with the catalyst coating layer is not limited, but a technique known in the art such as a wash coating method can be used.

In addition, in the method for supporting the solution containing Pd and Pt prepared in the process (i) on the substrate coated with the catalyst coating layer, the solution containing Pd and Pt prepared in the process (i) may be directly supported on the substrate coated with the catalyst coating layer by a wash coating method or the like but the solution containing Pd and Pt prepared in the process (i) may be supported in advance on a catalyst carrier, for example, metal oxides, for example, particles composed of silica, magnesium oxide, zirconia, ceria, alumina, titania, yttria, neodymium oxide and solid solutions and composite oxides thereof, and as well as combinations of two or more thereof, and the obtained suspension may then be supported on the substrate or the substrate coated with the catalyst coating layer by a wash coating method or the like.

For example, in the method for supporting the solution containing Pd and Pt prepared in the process (i) on the substrate coated with the catalyst coating layer, when 5 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), as the solution containing Pd and Pt prepared in the process (i), 15 g of a solution (the concentration of precious metals (Pd and Pt): 5.57 weight %) containing 0.835 g of precious metals (Pd and Pt) as metals and a solvent is applied to the catalyst coating layer part of the substrate coated with the catalyst coating layer (water is absorbed), and thus precious metals (Pd and Pt) can be supported on the catalyst coating layer.

In addition, in the method for supporting the solution containing Pd and Pt prepared in the process (i) on the substrate coated with the catalyst coating layer, the solution containing Pd and Pt can be supported on the catalyst coating layer two or more times in a divided manner.

For example, in the method for supporting the solution containing Pd and Pt prepared in the process (i) on the substrate coated with the catalyst coating layer, when 10 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), first, as the solution containing Pd and Pt prepared in the process (i), 15 g of a first solution (the concentration of precious metals (Pd and Pt): 5.57 weight %) containing 0.835 g of precious metals (Pd and Pt) as metals and a solvent is applied to the catalyst coating layer part of the substrate coated with the catalyst coating layer (water is absorbed), dried (the solvent content is removed) and optionally baked, and as the solution containing Pd and Pt prepared in the process (i), 15 g of a second solution (the concentration of precious metals (Pd and Pt): 5.57 weight %) containing 0.835 g of precious metals (Pd and Pt) as metals and a solvent is then applied to the catalyst coating layer part of the substrate coated with the catalyst coating layer supporting the first solution (water is absorbed), and thus precious metals (Pd and Pt) can be supported on the catalyst coating layer.

For example, in the method for supporting the solution containing Pd and Pt prepared in the process (i) on the substrate coated with the catalyst coating layer, when 8 g/L of precious metals (Pd and Pt) per 1 L volume of the substrate is supported on the catalyst coating layer part of the substrate coated with the catalyst coating layer (the volume of the substrate is 167 cc, and the water absorption amount of the substrate is 90 g/L per 1 L volume of the substrate), first, as the solution containing Pd and Pt prepared in the process (i), 15 g of a first solution (the concentration of precious metals (Pd and Pt): 5.57 weight %) containing 0.835 g of precious metals (Pd and Pt) as metals and a solvent is applied to the catalyst coating layer part of the substrate coated with the catalyst coating layer (water is absorbed), dried (the solvent content is removed) and optionally baked, and as the solution containing Pd and Pt prepared in the process (i), 15 g of a second solution (the concentration of precious metals (Pd and Pt): 3.34 weight %) containing 0.501 g of precious metals (Pd and Pt) as metals and a solvent is then applied to the catalyst coating layer part of the substrate coated with the catalyst coating layer supporting the first solution (water is absorbed), and thus precious metals (Pd and Pt) can be supported on the catalyst coating layer.

In the process (ii) of the present disclosure, when Pd and Pt are supported on the catalyst coating layer on the substrate using the prepared solution containing Pd and Pt at specific proportions in the process (i), it is possible to produce a catalyst for exhaust gas purification having favorable warm-up properties compared to supporting Pd and Pt separately.

In the process (ii) of the present disclosure, the solution containing Pd and Pt prepared in the process (i) is preferably supported on the catalyst coating layer upstream from the substrate.

Here, the upstream side from the substrate indicates a range from an upstream part from the upstream-side end (also referred to as an “Fr end”) of the substrate in the exhaust gas flow direction in the catalyst for exhaust gas purification to 50% or less of the total length of the substrate.

In the process (ii) of the present disclosure, the solution containing Pd and Pt prepared in the process (i) is more preferably supported on the catalyst coating layer upstream from the substrate at a part ranging from the Fr end to 20% to 30% of the total length of the substrate.

In the process (ii) of the present disclosure, the solution containing Pd and Pt prepared in the process (i) is supported on the catalyst coating layer upstream from the substrate, and thus HC and CO in the exhaust gas can be actively removed by purification upstream from the catalyst for exhaust gas purification, it is possible to minimize poisoning of Rh by HC and CO which may exist on the downstream side, and it is possible to efficiently remove NOx in the exhaust gas on the downstream side by purification. In addition, in the process (ii) of the present disclosure, when the solution containing Pd and Pt prepared in the process (i) is supported on the catalyst coating layer upstream from the substrate, it is possible to reduce the amount of precious metals used in the catalyst for exhaust gas purification, and it is possible to reduce cost of the catalyst for exhaust gas purification.

In the process (ii) of the present disclosure, in the substrate containing the catalyst coating layer on which the solution containing Pd and Pt prepared in the process (i) is supported, an excess solution blows off with a blower or the like, and for example, drying is then performed in air at 100° C. to 150° C. for 1 hour to 3 hours, the solvent content is removed, and baking is performed in air at 450° C. to 550° C. for 1 hour to 3 hours.

The catalyst for exhaust gas purification produced by the production method of the present disclosure is a catalyst for exhaust gas purification including a substrate, a catalyst coating layer on the substrate, and Pd and Pt supported on the catalyst coating layer. In the catalyst for exhaust gas purification, Pd and Pt are supported by applying a solution containing Pd and Pt obtained by dissolving a Pd precursor and a Pt precursor in a solvent to the catalyst coating layer, and the content of Pt in the solution containing Pd and Pt with respect to a total weight of Pd and Pt is 85 weight % or less, and preferably 75 weight % or less.

The catalyst for exhaust gas purification produced by the production method of the present disclosure is specified by matters specifying the disclosure “Pd and Pt are supported by applying a solution containing Pd and Pt obtained by dissolving a Pd precursor and a Pt precursor in a solvent to the catalyst coating layer,” and it has better warm-up properties than a catalyst for exhaust gas purification produced by supporting Pd and Pt separately, according to the matters specifying the disclosure.

The catalyst for exhaust gas purification produced by the production method of the present disclosure is specified by the production method described above because an existence form of Pd and Pt supported on the catalyst coating layer in the catalyst for exhaust gas purification cannot be expressed by an existing evaluation method.

For example, even when a distribution state of Pd and Pt on the surface of the catalyst coating layer in the catalyst for exhaust gas purification was analyzed using an electron beam microanalyzer (EPMA), no significant structural difference was found between the catalyst for exhaust gas purification produced by the production method of the present disclosure and the catalyst for exhaust gas purification produced by supporting Pd and Pt separately.

Therefore, it is thought that, in the catalyst for exhaust gas purification produced by the production method of the present disclosure, a finer part, which cannot be expressed by the existing evaluation method, for example, a mutual bonding state and/or distribution state of Pd and Pt in a range of several Å to several nm, has a large effect on the warm-up performance of the catalyst for exhaust gas purification. For example, when Pd having better durability than Pt is present adjacent to Pt, Pd inhibits sintering of Pt and can impart a favorable warm-up performance effect of the catalyst for exhaust gas purification after long-term use. However, the scope of the present disclosure is not limited by the above presumption.

Here, even if the difference between the existence form of Pd and Pt on the catalyst coating layer in the catalyst for exhaust gas purification produced by the production method of the present disclosure and the existence form of Pd and Pt on the catalyst coating layer in the catalyst for exhaust gas purification produced by supporting Pd and Pt separately can be evaluated by another analysis method, this is impractical because it takes much effort to find such an analysis method and also find an appropriate measurement method and measurement conditions.

As described above, the catalyst for exhaust gas purification produced by the production method of the present disclosure is specified by matters specifying the disclosure “Pd and Pt are supported by applying a solution containing Pd and Pt obtained by dissolving a Pd precursor and a Pt precursor in a solvent to the catalyst coating layer.”

The catalyst for exhaust gas purification produced by the production method of the present disclosure can be mainly used as a catalyst for exhaust gas purification from an internal combustion engine for automobiles, and particularly, as a catalyst for exhaust gas purification (that is, a catalyst for exhaust gas purification provided in the front stage) immediately after an internal combustion engine for automobiles.

Hereinafter, several examples related to the present disclosure will be described, but the present disclosure is not intended to be limited to such examples.

### I. Production of Catalyst for Exhaust Gas Purification

Monolith substrate used: monolith substrate (volume: 875 cc, substrate length: 105 mm, substrate diameter: 103 mm, the number of cells: 600 cells/(inch)², and wall thickness: 65 μm)

### Comparative Example 1

(1) A first slurry containing Pd, Al₂O₃, CeO₂—ZrO₂, and water was applied over the entire monolith substrate and then dried (120° C.; 1 hour) and baked (500° C., 2 hours) and thus a first catalyst coating layer (a lower catalyst coating layer containing 0.4 g/L of Pd, 106 g) was formed on the monolith substrate. Next, a second slurry containing Rh, Al₂O₃, CeO₂—ZrO₂, and water was applied to the lower catalyst coating layer on the monolith substrate and then dried (120° C., 1 hour) and baked (500° C., 2 hours), and thus a second catalyst coating layer (an upper catalyst coating layer containing 0.3 g/L of Rh, 84 g) was formed on the lower catalyst coating layer.

(2) Subsequently, a Pd nitrate aqueous solution (15 g) containing Pd (1.25 g of Pd metal) and water was applied from the end (Fr end when installed as the catalyst for exhaust gas purification) upstream from the monolith substrate having the lower catalyst coating layer and the upper catalyst coating layer to a position of 20 mm (water was absorbed) for support, and then dried (120° C., 1 hour) and baked (500° C., 2 hours) to produce a catalyst for exhaust gas purification.

### Comparative Example 2

A catalyst for exhaust gas purification was produced in the same manner as in Comparative Example 1 except that “a dinitrodiammine Pt aqueous solution (15 g) containing Pt (1.25 g of Pt metal) and water” was used in place of the “Pd nitrate aqueous solution (15 g) containing Pd (1.25 g of Pd metal) and water” in the process (2) in Comparative Example 1.

### Comparative Example 3

A catalyst for exhaust gas purification was produced in the same manner as in Comparative Example 1 except that, in place of the process (2) in Comparative Example 1, the following process (2′) in which, subsequently, a dinitrodiammine Pt aqueous solution (15 g) containing Pt (0.417 g of Pt metal) and water was subjected to water absorption from the end (Fr end when installed as the catalyst for exhaust gas purification) upstream from the monolith substrate having the lower catalyst coating layer and the upper catalyst coating layer to a position of 20 mm for support and then dried (120° C., 1 hour) and baked (500° C., 2 hours), and furthermore, a Pd nitrate aqueous solution (15 g) containing Pd (0.833 g of Pd metal) and water was subjected to water absorption from the end (Fr end when installed as the catalyst for exhaust gas purification) upstream from the monolith substrate having the lower catalyst coating layer and the upper catalyst coating layer as well as a Pt layer in a range of 20 mm from the upstream side end to a position of 20 mm for support, and then dried (120° C., 1 hour) and baked (500° C., 2 hours) to produce a catalyst for exhaust gas purification was used.

### Comparative Example 4

A catalyst for exhaust gas purification was produced in the same manner as in Comparative Example 1 except that, in place of the process (2) in Comparative Example 1, the following process (2″) in which, subsequently, a dinitrodiammine Pt aqueous solution (15 g) containing Pt (0.625 g of Pt metal) and water was subjected to water absorption from the end (Fr end when installed as the catalyst for exhaust gas purification) upstream from the monolith substrate having the lower catalyst coating layer and the upper catalyst coating layer to a position of 20 mm for support and then dried (120° C., 1 hour) and baked (500° C., 2 hours), and furthermore, a Pd nitrate aqueous solution (15 g) containing Pd (0.625 g of Pd metal) and water was subjected to water absorption from the end (Fr end when installed as the catalyst for exhaust gas purification) upstream from the monolith substrate having the lower catalyst coating layer and the upper catalyst coating layer as well as a Pt layer in a range of 20 mm from the upstream side end to a position of 20 mm for support, and then dried (120° C., 1 hour) and baked (500° C., 2 hours) to produce a catalyst for exhaust gas purification was used.

### Comparative Example 5

A catalyst for exhaust gas purification was produced in the same manner as in Comparative Example 1 except that, in place of the process (2) in Comparative Example 1, the process (2″′) in which, subsequently, a dinitrodiammine Pt aqueous solution (15 g) containing Pt (0.833 g of Pt metal) and water was subjected to water absorption from the end (Fr end when installed as the catalyst for exhaust gas purification) upstream from the monolith substrate having the lower catalyst coating layer and the upper catalyst coating layer to a position of 20 mm for support and then dried (120° C. 1 hour) and baked (500° C., 2 hours), and furthermore, a Pd nitrate aqueous solution (15 g) containing Pd (0.417 g of Pd metal) and water was subjected to water absorption from the end (Fr end when installed as the catalyst for exhaust gas purification) upstream from the monolith substrate having the lower catalyst coating layer and the upper catalyst coating layer as well as a Pt layer in a range of 20 mm from the upstream side end to a position of 20 mm for support and then dried (120° C., 1 hour) and baked (500° C., 2 hours) to produce a catalyst for exhaust gas purification was used.

### Comparative Example 6

A catalyst for exhaust gas purification was produced in the same manner as in Comparative Example 1 except that, in place of the process (2) in Comparative Example 1, the following process (2″″) in which, subsequently, a Pd nitrate aqueous solution (15 g) containing Pd (0.417 g of Pd metal) and water was subjected to water absorption from the end (Fr end when installed as the catalyst for exhaust gas purification) upstream from the monolith substrate having the lower catalyst coating layer and the upper catalyst coating layer to a position of 20 mm for support and then dried (120° C., 1 hour) and baked (500° C., 2 hours), and furthermore, a dinitrodiammine Pt aqueous solution (15 g) containing Pt (0.833 g of Pt metal) and water was subjected to water absorption from the end (Fr end when installed as the catalyst for exhaust gas purification) upstream from the monolith substrate having the lower catalyst coating layer and the upper catalyst coating layer as well as a Pd layer in a range of 20 mm from the upstream side end to a position of 20 mm for support and then dried (120° C., 1 hour) and baked (500° C., 2 hours) to produce a catalyst for exhaust gas purification was used.

### EXAMPLE 1

A catalyst for exhaust gas purification was produced in the same manner as in Comparative Example 1 except that “a mixed aqueous solution (15 g) of a Pd nitrate aqueous solution containing Pd (0.417 g of Pd metal) and water and a dinitrodiammine Pt aqueous solution containing Pt (0.833 g of Pt metal) and water” was used in place of the “Pd nitrate aqueous solution (15 g) containing Pd (1.25 g of Pd metal) and water” in the process (2) in Comparative Example 1.

### EXAMPLE 2

A catalyst for exhaust gas purification was produced in the same manner as in Comparative Example 1 except that “a mixed aqueous solution (15 g) of a Pd nitrate aqueous solution containing Pd (0.313 g of Pd metal) and water and a dinitrodiammine Pt aqueous solution containing Pt (0.938 g of Pt metal) and water” was used in place of the “Pd nitrate aqueous solution (15 g) containing Pd (1.25 g of Pd metal) and water” in the process (2) in Comparative Example 1.

### EXAMPLE 3

A catalyst for exhaust gas purification was produced in the same manner as in Comparative Example 1 except that “a mixed aqueous solution (15 g) of a Pd nitrate aqueous solution containing Pd (0.250 g of Pd metal) and water and a dinitrodiammine Pt aqueous solution containing Pt (1.00 g of Pt metal) and water” was used in place of the “Pd nitrate aqueous solution (15 g) containing Pd (1.25 g of Pd metal) and water” in the process (2) in Comparative Example 1.

Table 1 summarizes catalyst configurations of the catalysts for exhaust gas purification of Comparative Examples 1 to 6 and Examples 1 to 3. Here, in the table, [g/L] in the “upstream part (20 mm) precious metal amount” is a unit indicating the weight per 1 L volume of the upstream part (up to 20 mm from the Fr end) of the catalyst for exhaust gas purification, and [g/L] in the “lower catalyst coating layer” and “upper catalyst coating layer” is a unit indicating the weight per 1 L volume of the catalyst for exhaust gas purification.

TABLE 1
Catalyst configuration

| | Upstream part (20 mm) | | | | | Lower catalyst | | Upper catalyst | |
|---|---|---|---|---|---|---|---|---|---|
| | precious metal amount * | | | | Supporting | coating layer | | coating layer | |
| | Pd | | Pt | | order | Pd | CZ + Al₂O₃ | Rh | CZ + Al₂O₃ |
| Example 1 | 2.5 g/L | 33 wt. % | 5 g/L | 67 wt. % | Pt, Pd | 0.4 g/L | 106 g/L | 0.3 g/L | 84 g/L |
| | | | | | simultaneously | | | | |
| Example 2 | 1.875 g/L | 25 wt. % | 5.625 g/L | 75 wt. % | Pt, Pd | 0.4 g/L | 106 g/L | 0.3 g/L | 84 g/L |
| | | | | | simultaneously | | | | |
| Example 3 | 1.5 g/L | 20 wt. % | 6 g/L | 80 wt. % | Pt. Pd | 0.4 g/L | 106 g/L | 0.3 g/L | 84 g/L |
| | | | | | simultaneously | | | | |
| Comparative | 7.5 g/L | 100 wt. % | — | 0 | — | 0.4 g/L | 106 g/L | 0.3 g/L | 84 g/L |
| Example 1 | | | | | | | | | |
| Comparative | — | 0 | 7.5 g/L | 100 wt. % | — | 0.4 g/L | 106 g/L | 0.3 g/L | 84 g/L |
| Example 2 | | | | | | | | | |
| Comparative | 5 g/L | 67 wt. % | 2.5 g/L | 33 wt. % | Pt->Pd | 0.4 g/L | 106 g/L | 0.3 g/L | 84 g/L |
| Example 3 | | | | | | | | | |
| Comparative | 3.75 g/L | 50 wt. % | 3.75 g/L | 50 wt. % | Pt->Pd | 0.4 g/L | 106 g/L | 0.3 g/L | 84 g/L |
| Example 4 | | | | | | | | | |
| Comparative | 2.5 g/L | 33 wt. % | 5 g/L | 67 wt. % | Pt->Pd | 0.4 g/L | 106 g/L | 0.3 g/L | 84 g/L |
| Example 5 | | | | | | | | | |
| Comparative | 2.5 g/L | 33 wt. % | 5 g/L | 67 wt. % | Pd->Pt | 0.4 g/L | 106 g/L | 0.3 g/L | 84 g/L |
| Example 6 | | | | | | | | | |

* excluding Pd contained in the lower catalyst coating layer

### II. Durability Test

For Comparative Examples 1 to 6 and Examples 1 to 3, the following durability test was performed using actual engines.

Each catalyst for exhaust gas purification was installed directly below an exhaust manifold of a V-type 8-cylinder-4.6 L engine, the catalyst bed temperature was set to 950° C., and the test was performed in an atmosphere with a composite pattern including stoichiometric F/B and fuel cut A/F variation for 50 hours.

### III. Performance Evaluation

For the catalysts for exhaust gas purification of Comparative Examples 1 to 6 and Examples 1 to 3 on which II. durability test was performed, and the following performance evaluation was performed.

### Time of Reaching HC-T50 Evaluation Test

A catalytic converter with a catalyst for exhaust gas purification was installed at an exhaust pipe from an in-line 4-cylinder-2.5 L gasoline engine, and an analyzer was connected to the inlet and the outlet for an incoming gas in the catalyst for exhaust gas purification. The exhaust pipe was branched upstream from the catalytic converter and an inflow of a gas to the catalyst for exhaust gas purification was evaluated by switching with a switching valve. In a state in which no gas flowed through the catalyst for exhaust gas purification, while performing controlling under a weak rich condition of A/F=14.4 using an air-fuel ratio sensor and air-fuel ratio control (ECU), the input temperature of the catalyst for exhaust gas purification was raised to 450° C. Then, the switching valve allowed a gas to flow through the catalyst for exhaust gas purification, components of the incoming gas on the inlet and outlet sides of the catalyst for exhaust gas purification were measured with an analyzer, and the proportion of incoming gas that was purified was calculated as a purification rate. The time taken from the start of a gas flow into the catalyst until HC was removed by 50% by purification was defined as “time of reaching HC-T50.”

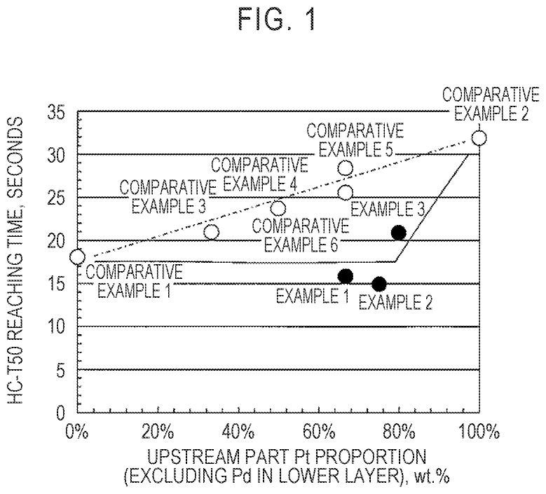

FIG. 1 shows the time of reaching HC-T50 (seconds) with respect to the proportion of Pt supported on the catalyst coating layer of the upstream part in the catalysts for exhaust gas purification of Comparative Examples 1 to 6 and Examples 1 to 3 ({Pt/(Pd+Pt)}×100, weight %) (excluding Pd contained in the lower catalyst coating layer). In FIG. 1, it can be understood that, comparing Comparative Example 1 (the proportion of Pt supported, 0 weight %) and Comparative Example 2 (the proportion of Pt supported, 100 weight %), Comparative Example 1 had a shorter time of reaching HC-T50 than Comparative Example 2. In addition, it can be understood that, regarding the change in the time of reaching HC-T50 according to the change in the proportion of Pt supported in Comparative Example 1 to Comparative Example 2, in Comparative Examples 3 to 6, when the proportion of Pt supported increased, the time of reaching HC-T50 also increased proportionally, but in Examples 1 and 2, although the proportion of Pt supported increased, the time of reaching HC-T50 was shorter than that of Comparative Example 1, and even if the proportion of Pt supported increased to that of Example 3 (the proportion of Pt supported, 80 weight %), the time of reaching HC-T50 was shorter than the time of reaching HC-T50 estimated from the comparative examples, and was the same as that of Comparative Example 1.

Here, regarding the catalysts for exhaust gas purification of Comparative Examples 5 and 6 and Example 1 having the same proportion of Pt supported, in order to evaluate the difference in the catalyst structure, the distribution state of Pd and Pt on the surface of the catalyst for exhaust gas purification was analyzed with EPMA, but no significant structural difference was found between the catalysts for exhaust gas purification of Comparative Examples 5 and 6 (catalyst for exhaust gas purification produced by supporting Pd and Pt separately) and the catalyst for exhaust gas purification of Example 1 (the catalyst for exhaust gas purification produced by simultaneously supporting Pd and Pt produced by the production method of the present disclosure).

What is claimed is:

1. A method of producing a catalyst for exhaust gas purification, comprising:
(i) a process in which a Pd precursor and a Pt precursor are dissolved in a solvent to prepare a solution containing Pd and Pt, the content of Pt with respect to a total weight of Pd and Pt being 85 weight % or less in the solvent; and
(ii) a process in which the solution containing Pd and Pt prepared in the process (i) is supported on a catalyst coating layer.

2. The method according to claim 1,
wherein, in the solvent containing Pd and Pt prepared in the process (i), the content of Pt with respect to a total weight of Pd and Pt is 75 weight % or less.

3. The method according to claim 1,
wherein, in the process (ii), the solution containing Pd and Pt prepared in the process (i) is supported on the catalyst coating layer upstream from a substrate.

4. A catalyst for exhaust gas purification, comprising:
a substrate;
a catalyst coating layer on the substrate; and
Pd and Pt supported on the catalyst coating layer,
wherein Pd and Pt are supported by applying a solution containing Pd and Pt obtained by dissolving a Pd precursor and a Pt precursor in a solvent to the catalyst coating layer, and
wherein the content of Pt in the solution containing Pd and Pt with respect to a total weight of Pd and Pt is 85 weight % or less.
